(19) United States
(12) Patent Application Publication
(10) Pub. No.: US 2010/0216106 A1
(43) Pub. Date: Aug. 26, 2010

(54) SYSTEM AND METHOD FOR LEARNING STRUCTURE USING ENVELOPES

(76) Inventors: Patricia Rosalind McKee, Oakville (CA); Anne Maria Reet Agur, Toronto (CA)

Correspondence Address: MILLER THOMPSON, LLP, Scotia Plaza, 40 King Street West, Suite 5800, TORONTO, ON, M5H 3S1, CA

(21) Appl. No.: 12/711,464

(22) Filed: Feb. 24, 2010

Related U.S. Application Data
(60) Provisional application No. 61/154,993, filed on Feb. 24, 2009.

(51) Int. Cl. G09B 23/28; G09B 23/30

(52) U.S. Cl. 434/272; 434/274

(57) ABSTRACT

The present invention discloses a method and system for enabling the learning of a portion of anatomy. The system of the present invention comprises a learner; an envelope worn by the learner, another person, or an animal; media to instruct the learner on anatomy; and an annotation tool enabling the learner to annotate the anatomy on the envelope. The present invention may be used for any part of human or non-human anatomy.

### PRIORITY CLAIMED

This application claims the benefit of U.S. Patent Application No. 61/154,993, filed on Feb. 24, 2009.

### FIELD OF THE INVENTION

The present invention relates to tools for teaching internal aspects of structures that provide learners with an opportunity to personally relate to the structures.

### BACKGROUND TO THE INVENTION

Techniques presently exist for teaching students/health professionals to understand the internal components, functions and dynamics of various structures, including physiological, biological, mechanical, chemical, and electrical structures. These structures can be man made or natural, large or small, and include various shapes. By teaching students about these structures, it has been possible to increase society's knowledge of flora, fauna, humans, and human made creations.

For example, within the realm of medical teaching, students have a need to learn anatomy. Anatomy is an essential component of professional education for medical and other health students. It is important for graduates from these programmes to understand the complex anatomy and function of body parts such as the hand. Additionally, professionals often seek opportunities to refresh and enhance their knowledge.

Current media used for teaching anatomy include: written materials (e.g. textbooks), dissection, prosections (previously dissected specimens), plastic models, computer software and videos. The gold standard for learning anatomy is generally considered to be anatomy dissection. A step down is to provide the learner with prosections. Due to the very high cost of the resources required to provide either dissection or prosection media, many education programmes are unable to provide this optimal learning. Like dissection and prosections, plastic models are used to help the learner to appreciate the three dimensional aspects of anatomy. All other media are limited to the use of 2D images to represent complex 3D structures. In fact, some educational health professional programmes actually do not provide a formal anatomy course. No existing media provides an opportunity to personally relate to the anatomy underneath one's skin. This personal relation is desirable as it enhances learning.

Similarly, to learn other skills, such as automobile repair, one would typically have to practise disassembly and reassembly of expensive parts such as engines, transmissions, and exhaust systems. It is therefore out of the reach of many students and teaching facilities to obtain sufficient training methods to teach these skills.

Therefore, what is required is a method and system whereby a learner is given the opportunity to personally relate to structures regardless of the availability of dissection or prosection media. What is also required is an opportunity for enabling interactive learning along with meaningful and real-time feedback to enhance comprehension of the function of the structures being learned.

### SUMMARY OF THE INVENTION

In one aspect of the present invention, a method for enabling the learning of a structure is provided, the method comprising: (a) a learner being supplied with an envelope, the envelope being in about the shape and about the size of the structure such that it envelopes the structure; (b) the learner being supplied with media operable to instruct the learner on internal characteristics of the structure; and (c) the learner being supplied with an annotation tool, the annotation tool enabling the learner to annotate the envelope with the internal characteristics corresponding to the structure.

In another aspect of the present invention, a system for enabling the learning of a structure is provided, the system comprising: (a) a learner; (b) an envelope, the envelope being in about the shape and about the size of the structure such that it envelopes the structure; (c) media operable to instruct the learner on internal characteristics of the structure; and (d) an annotation tool, the annotation tool enabling the learner to annotate the envelope with the internal characteristics corresponding to the structure.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

FIG. 1 illustrates one aspect of the present invention in which the anatomy of the human hand is being learned, and in which the envelope depicts all hand bones in their anatomically correct form.

FIG. 2 illustrates a method by which a learner annotates muscles on the system of the present invention, in one aspect thereof, building up the layers from deep to more superficial

FIG. 3 illustrates the appearance of the system of the present invention, in one aspect thereof, after some of the muscles have been annotated onto the hand envelope.

FIG. 4 illustrates the finished appearance of the system of the present invention, in one aspect thereof, after the specified structures have been annotated onto the hand envelope.

FIG. 5 illustrates that the system of the present invention, in one aspect thereof, depicting some hand muscles beginning on the front of the hand and coursing around the side of the hand to the attach in the back of the hand.

FIG. 6 illustrates the flexible nature of the system of the present invention, in one aspect thereof, that permits the learner who is wearing the envelope move his/her joints.

FIG. 7 illustrates two muscles annotated on the system of the present invention, in one aspect thereof, and the respective surface anatomy on the living hand.

FIG. 8 illustrates surface anatomy while relating it to a dissected specimen.

FIG. 9 illustrates the function of some of the hand muscles.

FIG. 10 illustrates an example of a clinical condition.

In the drawings, embodiments of the invention are illustrated by way of example. It is to be expressly understood that the description and drawings are only for the purpose of illustration and as an aid to understanding, and are not intended as a definition of the limits of the invention.

Furthermore, it is to be expressly understood that lines shown as solid, dashed and dotted, which are used herein to distinguish different line types, could be distinguished using colours or other representations.

### DETAILED DESCRIPTION

### Overview

The present invention enables students or other interested persons (hereinafter referred to as “learners”) to learn or enhance knowledge of structures including the internal components, functions and dynamics of structures. As will be more fully described herein, the structures can encompass any natural or man made structure, including physiological, biological, mechanical, chemical, and electrical structures. Described herein, in one aspect of the present invention, is a general learning platform for contextual and situational visual explanations and interactions, enabling personal and social annotation for the purposes of enhancing learning of the structures involved.

The learning platform may comprise an enveloping element, an annotation tool, and media to enable learning. The enveloping element, which is further described below, generally is used to envelop the structure to be learned, and typically enables a view of the internal components and thus an understanding of functions of the structure. The annotation tool can be used to make annotations and other markings to the envelope. The media can be used to facilitate learning in connection with the use of the envelope and the annotation tool.

Although, as previously mentioned, the present invention is applicable to any structure, the following disclosure primarily describes an implementation wherein the structure is a human and the structural parts being learned are human anatomical features of, for example, a human hand. It should be understood that this disclosure is not meant to limit the scope of the present invention, but is rather intended to provide a more illustrative implementation of the present invention, in one aspect thereof. Further implementations are also described, but these too are not meant to be exhaustive of possible implementations of the present invention.

The present invention enables learners to learn the proper anatomy of any body part, such as the human hand. The present invention could easily be adapted to other body parts, with such adaptation simply requiring modification to the size and shape of the envelope provided by the present invention as well as modification to the internal anatomy applied to the envelope, in order to properly reflect the applicable body part or parts.

In addition, it is desirable that the invention be applied to a body part that can be enveloped and yet permit the learner to annotate such envelope. The foot, arm, leg, back, thorax, abdomen, head and neck would meet this criterion. It should be understood that a mirror may be used, for example, to make it easier to annotate features on the envelope, depending on the portion of anatomy in question. Furthermore, the present invention may be applied to a body part of another person, such that a learner could practice the methods of the present invention upon the other person. This scenario may be especially useful for learning anatomy of body parts for which it would be difficult to practice the methods of the present invention upon oneself. It should be understood that in such a scenario, the present invention may also be applied to an animal to enable learning of animal anatomy.

One objective of the method and system of the present invention is to enhance learners' knowledge of bones, muscles, nerves, blood vessels and function using both low and high tech media. Without limiting the scope of the present invention, the present invention may be desirable for use by learners in the following disciplines for learning, enhancing, or refreshing knowledge of body anatomy and function: occupational therapy, physical therapy, medicine, orthopedics, hand therapy/surgery, rheumatology, chiropractic, osteopathy, massage therapy, orthotics/prosthetics, rehabilitation engineering, biomedical engineering, medical art, physical education, chiropody and others.

### Implementation

The present invention may be thought of as comprising several components including an enveloping element (hereinafter referred to as an “envelope”), an annotation tool, and media.

### Envelope

One component of the present invention may be referred to as an “envelope”. The term “envelope” can actually refer to a class of elements that are each distinct, but perform a like function, including to cover/enclose a structure, visualize the structure and its internal components, functions and dynamics, interact with associated educational media, and enable or receive annotation to capture and reflect learning processes for the sharing of multiple perspectives. Therefore, the “envelope” may alternatively be a cloak, spotlight, or other element providing similar results to an envelope.

For example, an envelope itself may be an element that entirely covers the structure to be studied. Envelopes can be considered physical custom three dimensional shapes that volumetrically mimic the structure. The envelopes could be a flexible material so as to adapt to the shape of a structure. Alternatively, envelopes could come in general primitives, such as cubes, rectangular prisms, cylinders, or other shapes of varying sizes. These general envelopes can be placed over, and more generally cover the subject of inquiry, and may be translucent or opaque.

Cloaks can be laid on and cover a portion of a surface of a structure, be wrapped around the structure, or peered through framing a “scene” of the structure. Cloaks may be digital or non-digital, wherein non-digital cloaks may employ the use of static printed images on fabrics or other sheet material, and digital cloaks may be screens, flexible or not, that overlay digital information. Digital cloaks may be expressed as translucent displays or traditional displays used in conjunction with camera technologies.

Cloaks could also be enabled using a mobile device having camera capabilities and, ideally, a screen sufficient in size so as to appropriately represent the portion of the structure being cloaked. The mobile device may be placed on the surface or held over a structure to view layers of digital information, both static and dynamic. Scaling up, the cloak can be “peered through” to frame and select large objects or scenes to reveal visual information, lessons, quizzes and other educational media related to the framed subject of inquiry. These are more fully described below.

Ideally, the camera enables recognition of the structure being captured, in accordance with a recognition utility of the present invention. The recognition utility may be equipped with representations of structures to be learned as well as libraries of information about the internal components and functions of the structures. The recognition utility may take as input a digital image captured using the camera, and determine which structure is being learned. The recognition utility may then enable a user to select the particular internal component or function of the structure to be learned, and represent that component or function on the envelope. Users could also choose and apply a variety of filters that provide unique inside views, or animations of associated processes. The library could be updated and populated with new models and applications by communities of users and practitioners as new structures are learned. The recognition utility library could initially, or on an ongoing basis, be populated with images and/or texture maps generated by users. These could be generated both through use of envelopes or using a custom modelling application for a personal computer.

Spotlights, cast-light or projections are another form of envelope that may illuminate surface portions or the entire volume of a subject of inquiry. Thus the envelope can be extended as an application that can run on future instantiations of mobile handheld projectors and mobile devices equipped with projectors.

There may also be digital and non-digital spotlights/projections. Non-digital spotlights may include lamps that illuminate single or multiple static images printed on acetate. These images can be matched up with the subject of inquiry to be explored, annotated and “solved” by the learner. Digital spotlights may have the affordance for time based visualization as well as having the ability to display static images. Digital spotlights may be interactive, and provide visual feedback and trigger other forms of sensory feedback. These are more fully described below.

It should be noted that each of the envelope classes can be achieved in low technology versions using forms of paper, fabrics, card stock, synthetic and composite materials and existing pen and marker annotating devices. By no means are these classes of envelopes exhaustive as more may be added as appropriate materials are developed, and numerable variants within the classes that have been mentioned could easily be substituted or adapted to use as an envelope.

Additionally, the envelope classes can be implemented using existing and emerging digital imaging, display and visualization technologies and input devices. These technologies include touch display and gestural interfaces that enable optimal techniques of interacting with digital information. The display technologies may include video mapped projections, flexible OLED displays, electroluminescent wire (EL wire), polymer light emitting diode arrays, and electroluminescent fabric displays, each of which optimally merges the capabilities of digital display with custom envelope volumes.

Inclusion of digital display enables optimal visualization of static and dynamic images. In the context of anatomy learning, this may include biological processes like muscle contraction, digestion, circulatory dynamics, and electrical dynamics of the nervous system. For man made objects, dynamics such a how a device works can be visualized entirely in all its complexity, through time.

Furthermore, interactive images can allow for feedback-rich time based dialogical lessons directed to the learner. In one example for human-wearable envelopes with digital display and computational capabilities, a gestural language could be developed to interact with envelope media. Interactions such as scrubbing through information layers, mapped volumetric video, and the capture and playback of haptic video can be achieved with very specific intuitive movements of the hand, snapping of fingers, or other movements.

Also in accordance with human-wearable envelopes, tessellations of vibrating motors or micro-electro-mechanical systems (MEMS) actuators can be provided for enabling tactile feedback as well as visual. Thermal energy might be considered as well to enhance visual information, helping experientially with the learning process (mnemonic encoding).

Further, the envelope may be provided with an enhanced cleaning functionality. Envelopes could be “cleaned” or erased or otherwise returned to their original state by the application of light, sound, heat, vibration, water, or any other technique. These cleaning processes could correspond to either or both of the material of the envelope and the type or composition of the annotation tool used.

In many applications, the learning of internal components of a structure will require simulation of disassembly or cutting of the structure. In such cases, the envelope may be comprised of a self-healing material, which could for example be based on a rubber, polymer, polypropylene or other suitable material having a healing agent. In this way, the envelope may surround the structure and be physically cut into (so as to simulate skin or organic materials, for example), and be able to renew itself after required use.

For example, one particular application includes “self-dissection” whereby a learner is able to cut back layers and dissect the envelope as situated on a self-revealing true or abstract representation of biological or other internal systems. When finished, the envelope may “heal” itself back to its original form. This could also be applied to models/representations of other biological organisms (i.e. fish, insects, animals, plants, etc.) and could be supported by enhanced secondary media that is sensitive to the actions, progress and input onto the envelope. Further applications might explore various levels of complexity and fidelity and include in some cases micro-fluidic channels and conduits for simulating organic fluids and/or gases.

The secondary media may include envelopes having a current or sensor matrix which recognizes input and relays the input information to a media delivery system or computer vision systems whereby the learner is in front of a camera and image recognition software recognizes the changes of state on the envelope and relays this input information to a media delivery system. The media delivery system may use the input information to pull corresponding media such as video, audio or images from an online or other database.

The envelope could additionally be networked or identifiable so as to distinguish it amongst a plurality of like envelopes. For example, the envelopes may include a machine readable identification component such as a RFID chip. The identification component could enable the envelope to be linked to and indexed in correspondence with media as further described below. Telematic applications could also be provided using the envelope in accordance with the identification component.

A plurality of envelopes could also be networked for co-operative use applications. For example, individual and unique envelopes and annotation tools could be enabled with data transfer (communication) capabilities and networked to provide a greater collaborative system for shared or communal learning, work, applications, etc. In the context of anatomy learning, for example, each networked envelope may correspond to a particular and unique body part that, when combined with the other networked envelopes, forms a larger, complex and dynamic system representing the body or parts thereof. This could encourage and optimally enable a unique user experience with opportunities for learning through the modeling and representation of the whole of a structure in relation to its parts.

Additionally, individual, one time, or multiple use screens could be provided so that user can apply a set pattern to a blank envelope. The screens could be iron-on, silk-screen, or any other existing screen type. These could be used to provide high resolution background images or details.

The following description includes the use of a non-digital envelope, but any of the envelope classes referred to above could be provided in place of the non-digital envelope.

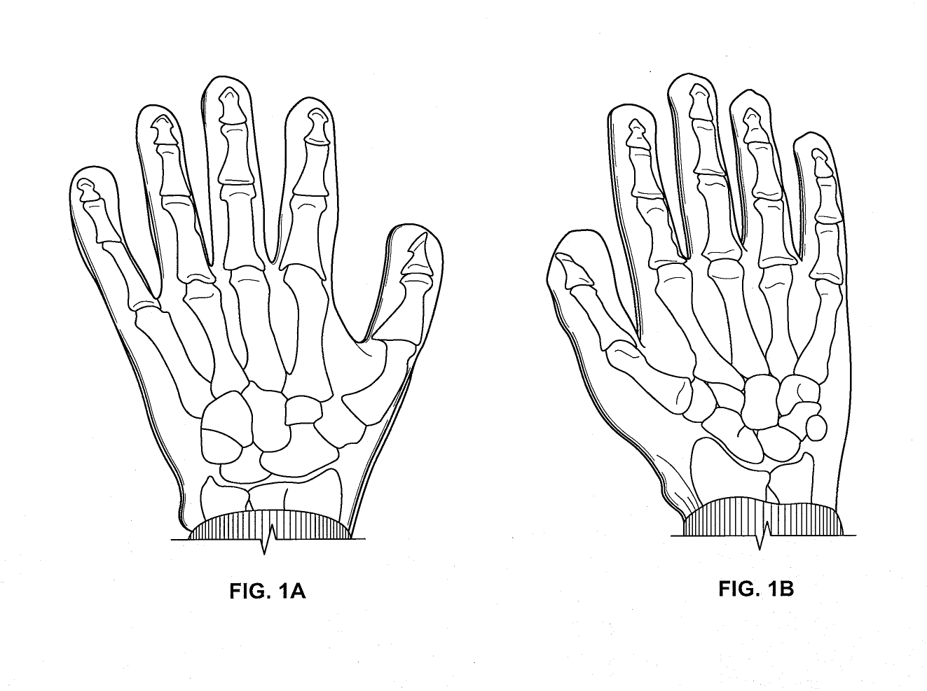

FIG. 1 illustrates one aspect of the present invention in which the anatomy of the hand is being learned, and in which all hand bones are in their anatomically correct form. FIG. 1a shows the front (palm) view while FIG. 1b shows the back view of the hand. In the case of a hand, the envelope may be a glove that shows all hand bones in their anatomically correct form. These bone features will have been applied to the envelope prior to delivering the envelope to the learner, in one aspect of the present invention. Alternatively, the learner could: annotate the bones onto a blank envelope in accordance with the methods herein described; be provided an envelope with bones and the anatomy pertaining to muscles, nerves or blood vessels shown faintly, to be colored by the learner; or be provided an envelope with some or all the anatomical structures shown in full color. Annotating the envelope could be enabled using the annotation tool described below.

### Annotation Tool

The present invention, in one aspect thereof, provides an annotation tool for making annotations upon the envelope.

If the envelope is an analogue material to be marked upon, the annotation tool may be any of a wide array of traditional and non-traditional marking devices. The marking device could be a colored pen, marker, or any other suitable ink or chemical based marking tool. The marking device may be used directly and traditionally on the surface of the analogue material. The marking device may be designed to work in tandem with digital versions of the envelope, such as an ink that can be applied to surfaces but only can be seen when a spotlight of particular wavelengths is shined or when a cloak is applied.

The marking tool may provide annotations that are washables or otherwise erasable, where reuse of the envelope is desired. Archiving of annotated envelopes may be provided by using digital photography, video, or other media. Alternatively, the marking tool may provide permanent annotations where the envelope is to be retained, or where the envelope is disposable. Furthermore, the annotations provided ideally comprise an ink that does not bleed on or through the envelope material so as to stain the structure being studied. Various forms of inks could be provided, including active inks, eco-inks, optical inks, or bio-luminescent inks.

Active inks may include inks that compliment the envelope material such that the annotations marked using the ink deteriorate over time, or where the particular ink can be selectively captured using an image capture system (such as those inks responsive to UV or infrared light), or inks that may be activated or caused to change state in some way by means such as various frequencies of sound waves, light waves, pulses of sound, or pulses of light.

Eco-inks may generally include those inks not containing volatile organic compounds (VOCs), for example. For disposability and student exposure, environmentally friendly solvent based inks made from renewable resources that do not contain VOCs with hazardous air pollutants (HAPs) may be provided. Such inks exist, but may have not been yet incorporated into marker form.

Optical inks may also be provided. Inks with special optical qualities may be used such that inks visible under specific frequencies of light could be used with a light stylus equipped with multiple sources of light to toggle or view multiple layers of information. A camera stylus may also be provided for taking images in each wavelength of light for further sharing and annotation on the web. Sharing of information is further described below.

Bio-luminescent inks may also be provided so that the envelope accepts compliments and enhances the application and functionality of bio-luminescent inks which could be stimulated to change state, such as using input from another source such as light, sound, electricity, or vibration. Multiple series of envelopes may be customized or tailored to provide specific functionality and user experiences based on the properties and functional affordances of such inks.

Further still, the marking tool may be one that cures, etches or burns the envelope material in some way that leaves a noticeable/discernable change of state.

If the envelope is a digital display to be marked upon, the annotation tool may be any suitable input device. In one implementation, the input device is a digital stylus that can communicate with the envelope through wireless means including near field, RFID, Bluetooth, WiFi, or other wireless communication protocol. Alternatively, the input device may be implemented on the envelope using pressure sensors, or light sensors that are operable to track UV and/or infrared lights, which may be provided on the stylus.

Where the envelope is a digital display, advanced annotation tools may be provided, including digital drawing tips, tools and manipulators, which are more fully described below. Where the envelope is an analogue medium, the advanced annotation tools may be provided using implements including various shapes, sizes, and colors of marking devices, such as scalpel shaped markers that are red in color to signify cuts for a medical student or, for an electrical engineering student, small marker objects that resemble capacitors, resistors and transistors all with associated colors, hues, shapes, and sizes.

The advanced annotation tools may include digital drawing tips, tools and manipulators. Particular tips may be applied to the annotation tool, where each tip is designed to agitate or activate the envelope material so that particular forms of lines, images, textures, or patterns appear. For example, a plurality of types of lines may be applicable to a particular structure to be studied. One tip could be provided corresponding to each type of line. Alternatively, varying wavelengths of emitted light (including laser, IR or UV) could enable the various lines to be shown.

The advanced annotation tools may also enable drawing and handwritten annotation that has variable and selectable line width, marker style, and color. The advanced annotation tools may also include an eraser. More advanced annotation functions corresponding to art, design, medical, or engineering specific tools that mimic more sophisticated disciplinary tools may also be provided. For example, in the medical field, a tool corresponding to a scalpel may be provided. Separate functions can be devised for picking operator functions for annotation and playing dynamics (such as electron flows in circuits).

Manipulators representing task-specific tools or interactive physical icons may be provided. Classes of toolsets can be created to mimic, in shape and function, disciplinary or professional tools, such as surgical tools, mechanical tools, electrical tools, etc. used to interact with digital envelope images overlaid on objects, places or people in context. These tool sets may enable optimal simulation for the field being learned. For example, within the field of medical learning, a set of medical tools could be provided for communicating with touch enabled flexible displays in the form of a glove or suit, or with external devices such as a camera system and projection system able to provide feedback. The tools could be used for simulating real world dynamics and responses of the body or materials. In other words, a student can interact in a simulated environment with the structure to be learned, as in a virtual environment but using the tools in connection with the envelope.

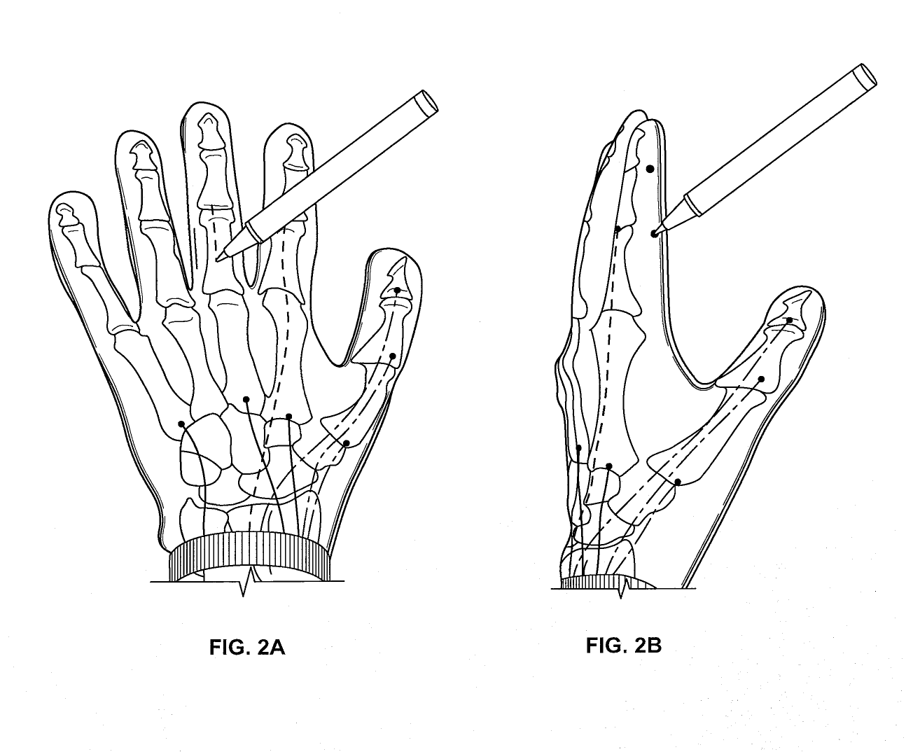

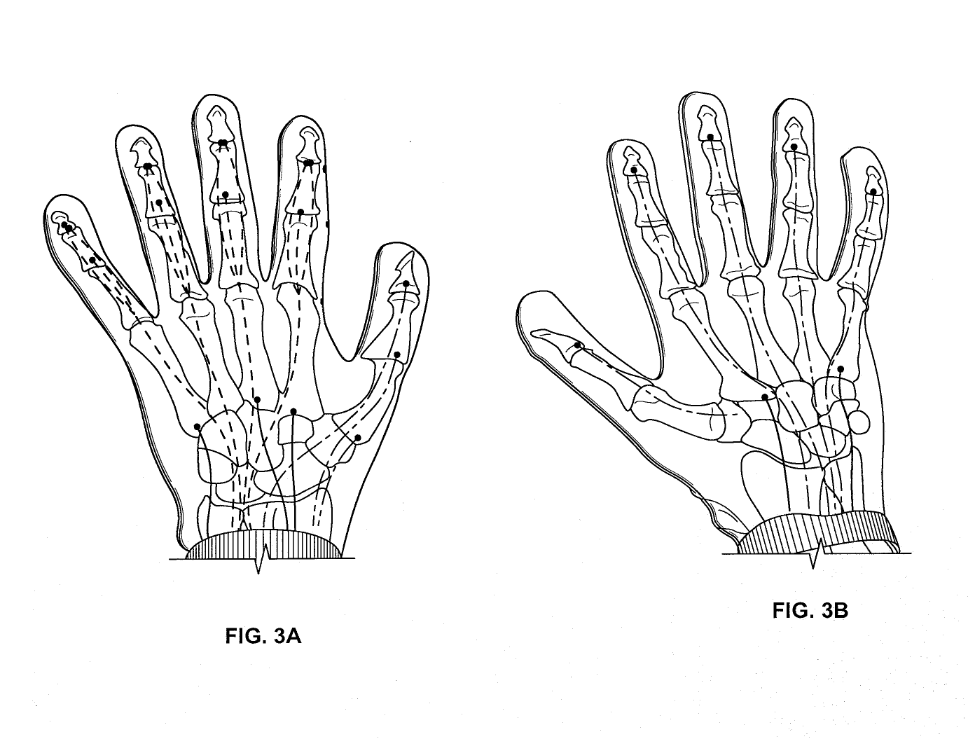

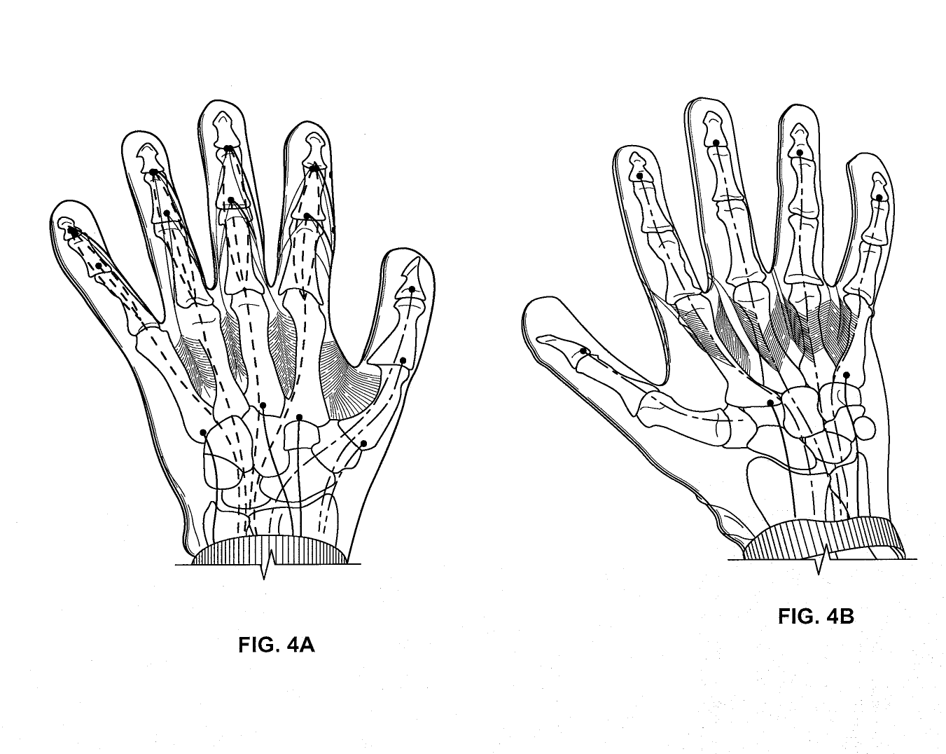

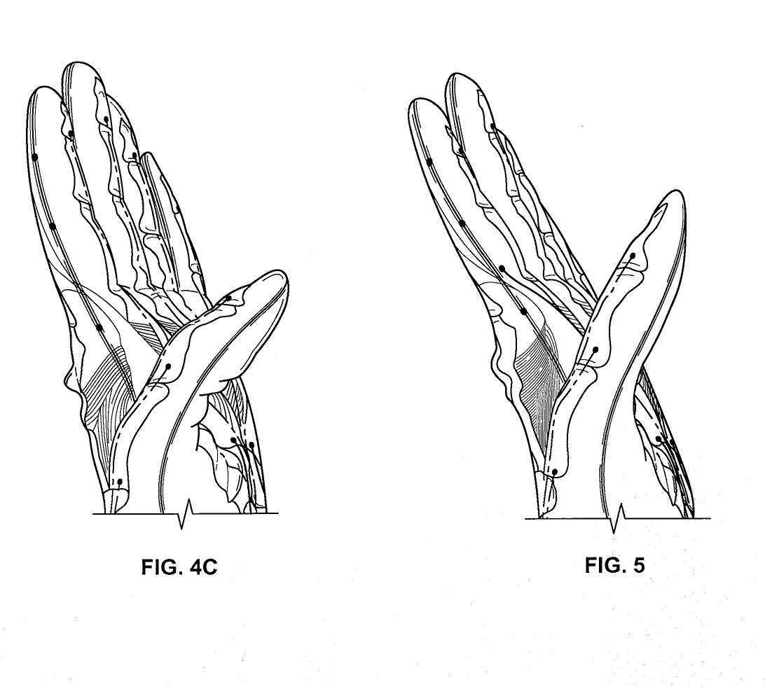

Within the context of medical learning, FIG. 2 illustrates a method by which a learner annotates muscles on the system of the present invention, in one aspect thereof, building up the layers from deep to more superficial. FIG. 3 illustrates the appearance of the system of the present invention, in one aspect thereof, after some of the muscles have been annotated onto the hand envelope. FIG. 4 illustrates the finished appearance of the system of the present invention, in one aspect thereof, after all of the muscles have been annotated to the hand envelope. After each segment is shown, the learner may be given the opportunity to annotate his or her own envelope with the anatomy with an annotation tool such as a marker or a set of markers, and may build up the layers from deep to more superficial.

This media could be used in classroom-based courses and online courses through universities and colleges. It could also be used as a self-directed learning tool for working professionals in the above mentioned disciplines. It should be understood that the present invention contemplates various media and presentations thereof to provide the segments to learners, and also various technologies for delivery, whether distribution of storage media containing the video content, webcasting or otherwise. It should also be understood that the video content described herein could be made to be interactive, to further enhance the learning experience.

The content presented using the media could also be tailored for patient/client education as a means of explaining the injury or pathology presented by the individual.

The benefits of the three dimensional property of the envelope have not been addressed in currently available solutions. One benefit may be to help the learner appreciate how some of the muscles start on one part of the body (such as the front of hand) and end on another part of the body (such as the back of hand)

FIG. 5 illustrates that the system of the present invention, in one aspect thereof, depicting some hand muscles beginning on the front of the hand and coursing around the side of the hand to the attach in the back of the hand. Such three-dimensional features are sometimes difficult to understand based on currently available methods. However, the interaction with the three-dimensional envelope and the marking of anatomical features, in accordance with the annotation tool described more fully herein, in three dimensions provides an opportunity for unique appreciation of these features not available in the prior art.

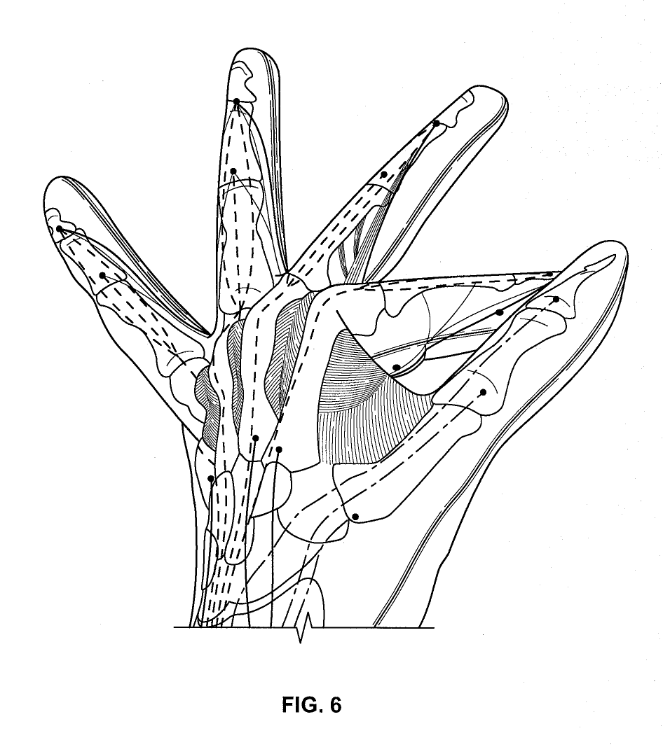

In addition, the envelope may be made to be flexible (by use of materials such as fabrics), allowing the learner to manipulate his or her anatomical part (such as bending the joints) to demonstrate the actions of the muscles while wearing the envelope. FIG. 6 illustrates the flexible nature of the system of the present invention, in one aspect thereof, that permits the learner who is wearing the envelope move his/her joints.

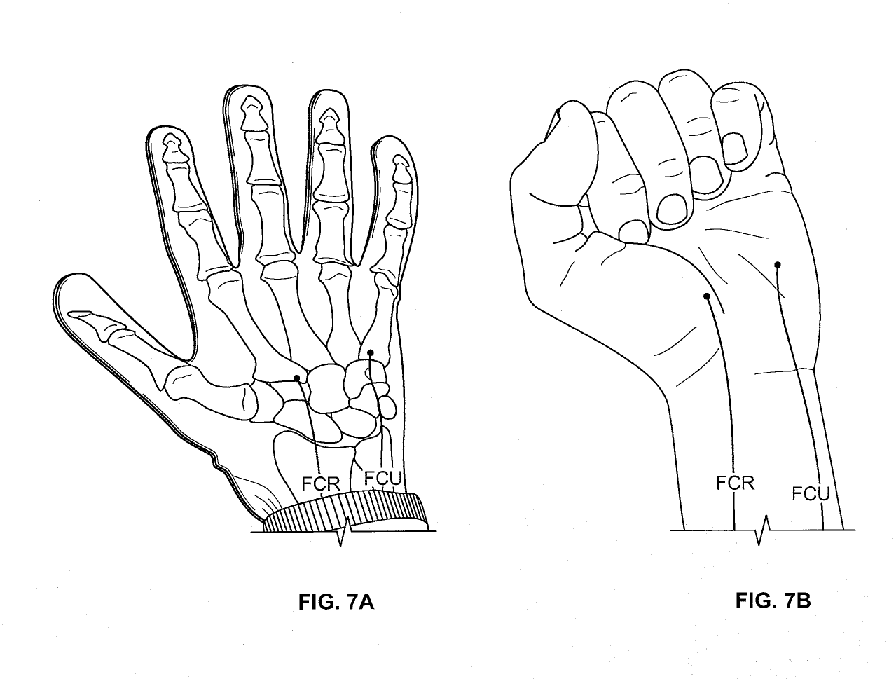

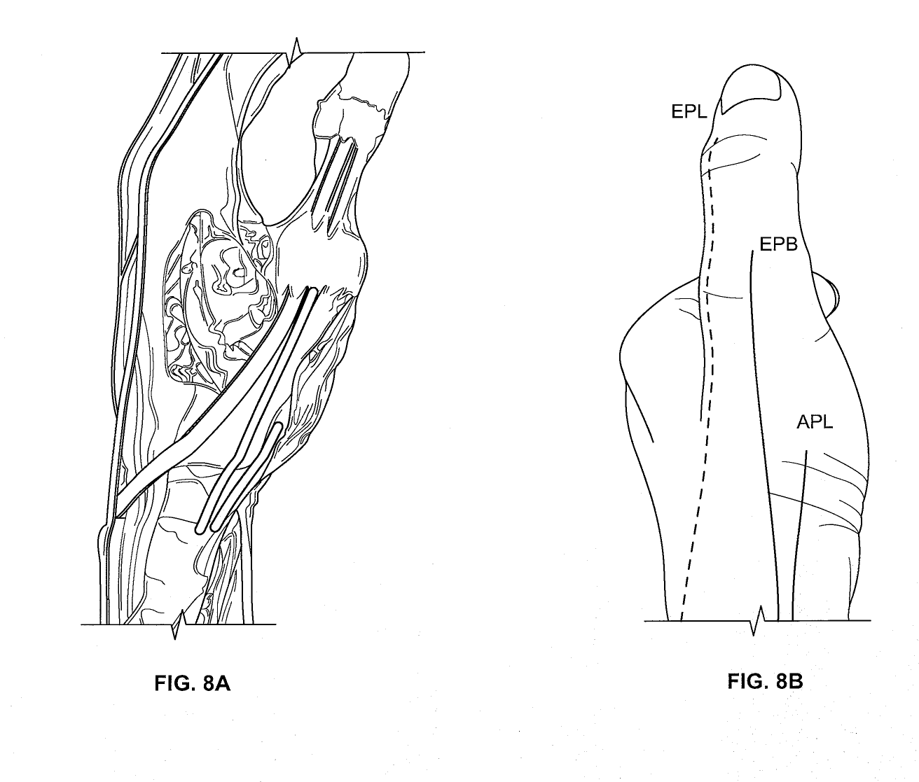

FIG. 7 illustrates two muscles annotated to the system of the present invention, in one aspect thereof, and the respective surface anatomy on the living hand. FIG. 8 illustrates surface anatomy while relating it to a dissected specimen. In accordance with these illustrations, the flexible nature of the envelope may enable certain anatomical features to be “felt” during the learning process, which in turn enhances comprehension through the palpable aspect of the learning. In other words, the present invention provides an opportunity for tactile learning of anatomy wherein the learner is interacting with his/her own anatomy. It is well known that education that engages more of a learner's senses typically provides more effective learning and retention. Furthermore, the present invention enables learners to personally relate to their own anatomy, in comparison to a plastic model for example, where there is no personal connection. This personal relationship also enhances comprehension by contributing to the richer learning experience that the present invention permits. These are important and unique characteristics that are not readily apparent. For example, the learner could study the anatomical structures that he/she has annotated the envelope with while observing and feeling the surface anatomy of the structures on the same or opposite side of his/her body, as illustrated in FIG. 7. The digital media may demonstrate how to locate and palpate the anatomical structures that can be felt through the skin, as illustrated in FIG. 8.

In another aspect of the present invention, quizzes can be added to the media to enhance the learning potential of the present invention.

### The Envelope

The envelope, in one example, may be made of a fabric material preferably stretchable in multiple directions, enabling a learner to envelop a portion of anatomy such that the material fits relatively snugly to conform to the contours of the learner's anatomy. The envelope may be sized and shaped to provide this snug fit, and may incorporate attachments of such types used in apparel generally, where appropriate. The envelope may be provided in a range of sizes, or one size fits all, depending on the material used and the anatomy portion in question.

The present invention contemplates that various changes could be made to enhance the fit of the envelope, and the ease in which annotations may be applied to the outside surface, without departing from the present invention.

In one aspect of the present invention, in an implementation for the human hand, a thin fabric glove is used, which is relatively inexpensive, has desirable stretchy characteristics and a sufficiently smooth outer surface on which to enable annotation of anatomical features, using, for example, one or more colored markers. It should be understood that the colors can be varied in order to provide sufficient contrast, so as to enable the learner to differentiate the layers from one another.

Optimally, the surface of the glove is smooth (non-textured) and receptive to annotation with the annotation tool, without running or bleeding of color. The annotation tool also optimally has a fine tip with an easy flow of color that dries quickly to prevent smearing. A range of colors may be used to represent the different anatomical structures. In an alternate implementation, the annotation tool could be comprised of stickers or appliqués representing the various anatomical structures. In addition to the envelope incorporating bony structures, the envelope could also be provided with the anatomical structures faintly outlined for the learner to color with the annotation tool. Another envelope variation could provide the bones and the anatomy fully represented. Finally, there is the possibility of creating envelopes that demonstrate musculoskeletal injury, such as a ruptured tendon, as illustrated in FIG. 10.

The envelope may be formed from a blank of fabric. Construction of the envelope may include (1) determining the size of the anatomy portion in question; (2) applying correctly-proportioned anatomical images corresponding to the front and back of the anatomical portion onto the blank; and (3) cutting and joining the front and back portion blanks. Preferably, the blank includes one or more registration marks for accurate alignment when joining the front and back panels.

The anatomical images can be applied by either (1) silk-screening using water-based inks that will be stretchy to correspond to stretching of the fabric; or (2) digital printing. Digital printing enables easy modification of the images, for example using computer software and a digital printer. The images can also be applied onto thin rubber gloves using a rotary peripheral attachment on the digital printer which enables printing on a non-flat substrate.

Cutting the front and back portion blanks can be achieved by hand cutting or using a die cutter. The front and back portion blanks can then be sewn together inside out, followed by turning the envelope right side out so the seam is inside the envelope. Alternatively, cutting and joining the front and back portion blanks can be achieved by ultrasonically cutting and welding the seams together. This process may require that the envelope comprises material that is substantially synthetic. Materials such as knitted polyester are suitable for ultrasonic welding, while having the desired two-way stretch.

### Media

The present invention, in one aspect thereof, may also comprise media to be used in connection with the envelope and annotation tool provided herein. In one aspect of the invention, the media is provided as video or photographic images. In another aspect of the invention, the media and written material is a plurality of web-based techniques for learning. In yet another aspect of the invention, a local connected or networked storage means is used to store lessons which are sent to a digital envelope. The media may generally be used to teach the learner about the internal components and functions of the structure to be learned. It should be noted that the use herein of the term “web-based” is intended to encompass any computer implemented technique, whether it takes place over the web, a local or wide area network, or even within a single computer apparatus that is connected by wire or wireless means to a digital envelope.

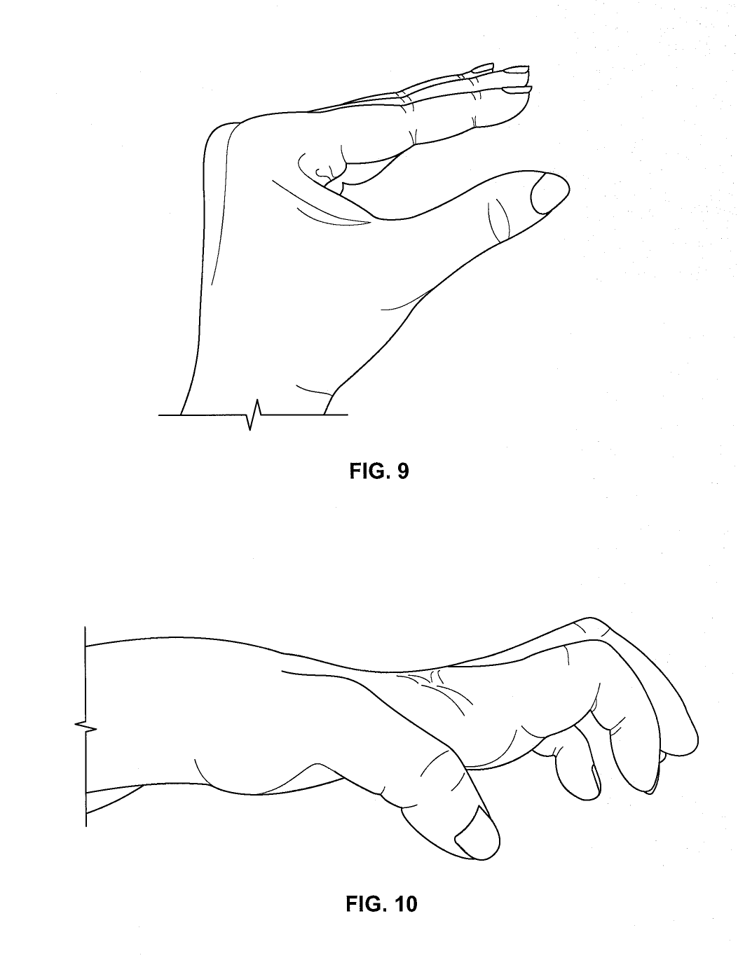

In the example wherein the structure is human anatomy, the media may be a sequence of video segments (also known as video clips), demonstrating the hand anatomy from the deepest layers to the most superficial layers using any or all of the following: dissected human specimens, illustrations, 3D anatomical models and animation. In one aspect of the present invention, where a sequence of video segments is displayed, each video segment may have the following components:
demonstration of the muscular anatomy on a dissected specimen, an illustration, a 3D anatomical model or an animation from the deepest to the most superficial layers, as illustrated in FIGS. 3 and 4;
surface anatomy illustrating how the anatomy can be seen on the surface of the living human, as illustrated in FIGS. 7 and 8;
function and innervation of the identified muscles;
annotating the envelope with the hand muscles, ligaments, nerves, and blood vessels, as illustrated in FIG. 2;
demonstration of muscle function, as illustrated in FIG. 9; and
common clinical conditions related to the anatomy, as illustrated in FIG. 10.

Alternative and as previously mentioned, the media may be any of a plurality of web based teaching techniques. These may vary from social media based applications to network-connected envelope based applications.

There may be provided a social media platform that supports class work, wherein a plurality of learners can collaborate to enable optimal and mutually beneficial learning environments. Learners can upload information including images such as photographs and video to be linked using a central database or repository. Capturing and archiving annotated envelopes can be done manually with a digital camera, for example, and uploaded to the database. One example of an implementation wherein this is beneficial includes a class-based assignment such that learners can annotate their respective envelopes and share assignment details. Users, including learners and teachers, can then search through each learner's submitted envelope, which may be linked to the database by project, lesson, student/learner, medical condition, etc.

Furthermore, the uploaded information can include texture-based data. Texture data corresponding to the dimensions of the structure (and, therefore, the envelope) can be associated with the uploaded images, such that the images are translated into texture maps that become a form of content. In the context of anatomy learning, for example, this can result in mapping of an interactive three dimensional model of a hand. Learners and teachers may scroll through each learner's attempts, make comments, and categorize reoccurring problems to feed back into curriculum development.

In accordance with the spotlight aspect of the envelope, non-digital envelopes may also be receptive to texture based image and video mapping. Projected displays could be directed to non-digital envelopes to map interactive three dimensional models of structures.

Further uses of media can be provided where the envelope is a digital envelope.

The digital envelope can be used as a platform for delivering and interacting with digital content. In accordance with different curriculum relating to the use of the envelope, new pieces of digital content may be rendered directly on the envelope. For example, in the context of anatomy learning, new treatments relating to different systems of the body may be viewed on the envelope depending upon the lesson to be taught. Content such as schematics, maps, and various other forms of numerical, analytical, text, image and video based content can be mapped and visualized directly onto the envelope. The context may be sent using a web based means or may be sent from a connected or local area storage and sending means.

Another example in the context of anatomy learning includes a tele-therapy application, wherein massage therapy points and sequences are sent to a networked or wired envelope which could be activated to demonstrate the points on the body that are to be massaged. Corresponding colors, shapes and light intensities may demonstrate the proper techniques and methods for massage or other medical/therapeutic procedures. Additionally a second glove-envelope or input device could be interacted with from a separate location by another person or system acting to guide or control or demonstrate the proper techniques.

Furthermore, annotations could be associated with further media. For example, image recognition tools could be used to associate particular annotations with particular components or functions of the structure to be learned. A linking utility can then link these annotations to other pre-existing or generated information about that function or structure, and this information can then be processed by a processing utility. Over time, a linked set of data can be generated for enhanced learning of the structure. Machine learning or artificial intelligence (AI) can also be enabled. Teaching computers and AI systems to predict and link human input to online or other supplemental/supporting media could be used to generate a correct/incorrect logic database which might be used for predictive modeling suggestions and corrections and anticipatory linking of support media and other tools.

Further links could be made with audio and visual annotations made by the learner or a teacher simultaneously with the marking of annotations, or after the fact. The linking of audio and images with annotations may enable association of persons to meta-data for semantic agent based search. Systems would make use of image and audio data for search and retrieval functions. For example, these systems could listen to and watch a learner interacting with the envelope and could extract key words or “tags” from the interaction. The key words may then be associated with the annotations and state changes observed on the envelope, and this knowledge may be contextualized and be made accessible to search algorithms for discovery by other learners.

Additionally, annotations made could be subject to a pattern recognition utility. For example, lines created on an envelope may correspond with a database consisting of images or data from which additional software based operations may occur. A system could employ still image scanning or make use of motion, video, or time-based media recognition. This could, for example, provide and demonstrate to the learner or other persons contextualized or corresponding media in real time during the annotation process. This might occur on any device with a screen such as a handheld device, tablet, gaming console or personal computer.

An envelope could be provided with a wire frame mesh for sub-layer representation (either physically embedded into the material or as a software based representation through image recognition) that can be manipulated by a learner for the purpose of altering either a software based representation of the envelope or the envelope itself. Such a system could integrate with the tools and functionality associated with a 3D CAD program. This could enable an application for physically interacting with the envelope in order to affect/re-form/alter a 3D software model, or vice versa. Image recognition, or a direct interface to a computer could link with the CAD system for the purpose of printing or prototyping the altered envelope in another form, such as computer aided cutting or milling, or stereo-lithography. The data files could also be uploaded to a database or library for later use and access. These could be distributed or shared across multiple software platforms. The translation of such data from analogue envelope models into digital form might also aid in the creation of software models for application in virtual worlds, such as in gaming.

### Learning Techniques

In one aspect of the present invention: (1) the envelope is provided to a learner, (2) the learner views the media, which may preferably be video in an established sequence; (3) the sequence of video segments would teach the learner about various aspects of anatomy, with focus on the anatomical features of the portion of the anatomy covered by the envelope; (4) the video segments will generally include interactive elements, prompting the learner to manipulate his/her own body and the envelope surrounding a portion of their anatomy to “feel” certain anatomical features; (5) after viewing each video segment, the learner adds anatomical features to the envelope by marking annotations of these features from the deep to the superficial (layers of features are marked on top of one another); and (6) the completed envelope can be used for immediate study, to gain an understanding of the locations and functions of the anatomical structures, and can be studied as needed in the future to refresh one's knowledge and, in some cases, prepare for examinations.

One of the challenging aspects of learning the structure and function of muscles is gaining an understanding of where the muscles actually attach to the bones. The video segments incorporated in the present invention may clearly show the muscle attachments and demonstrate to the learner where to annotate the structures. Once the learner has finished annotating the muscles with their bony attachments, he/she can visualize the course of the muscles in relation to joint axes, which can greatly enhance comprehension of the muscles' functions.

The video segments may range in length up to about 4 minutes and may be clearly labelled to identify the specific anatomical structures shown in each segment. The following is a sample of video segments that may correspond to the muscles of the hand:
A. Eminences and Wrist Flexors;
B. Flexor Digitorum Superficialis, Flexor Digitorum Profundus and Flexor Pollicus Longus;
C. Wrist Extensors;
D. Thumb Extensors;
E. Extensor Digitorum and Central Slip;
F. Lateral Bands;
G. Dorsal Interossei;
H. Palmar Interossei;
I. Lumbricals;
J. Extensor Expansion; and
K. Extensor Expansion and Injuries

Given the breadth of the video segments, the learner can pinpoint precisely which structures he/she wants to learn about or review.

Playback control for the video segments can rest with either a course instructor (classroom teaching with a projector and sound system) or individual learner who can view the segments on a computer or even a portable media player. Whoever has control can pause or replay the segments as desired. This contributes to desirable self-directed learning.

It should be understood that the video segments provide the learner with the opportunity to view and study from expertly dissected specimens that are costly to produce and only available to see first hand in the best university-based medical programmes. Multiple senses are employed—sight, sound, touch, kinaesthesia—as well as body motion on the part of the learner. When these video segments are combined with the tactile experience of the marking with the envelope, and interacting with one's own anatomy, as described, this provides a unique, enhanced anatomy learning experience.

### Further Implementations

Various additional implementations incorporating the envelope and annotation tools are herein provided.

For example, the envelope can be used as clothing to enable communication regarding the person wearing the clothing. For example, vitals clothing may be provided for consumers. The envelope that is worn by a person may be annotated using any of the annotation tools described above. Optimally, the envelope is a digital and flexible envelope that is annotated with the digital annotation tools. Annotations could be made by the wearer, or other stakeholders of the person. For example, a parent or health practitioner could make health related notes about the person. Optimally, the notes are made so that they are not always visible, but only become visible in accordance with one of the methods described above, such as by revealing the invisible messages using UV light. This can, for example, enable a collaborative wearable personal health record.

The envelope could also enable an optimal product housing and packaging application. The envelope could be annotated with information about the inside dynamics of the product where desirable. For example, in the context of retail goods, the envelope could be used to relate information regarding purchase support or use of the product. Other packaging applications could range from contextual static information such as graphical packaging to translucent interactive video boxes that contain the product. Product housing applications could range from raised-plastic static “x-ray” type graphical representations to the all-together merger of screen and product housing.

Envelopes could also be fabricated using moulds. Users could be provided with moulds and the necessary materials for creating duplicate envelopes. The mould may be re-usable and could be enhanced by patterns or other inserts designed to provide multiple and varying iterations of the related structure to be learned. A variety of moulds and inserts could be developed to high or low degrees of fidelity and representation. A mould's physical shape could also support, guide, or channel annotations.

Envelopes could be used as pedagogical tools for illustrating and prototyping topologies of a personal area networks, devices, implants, wearable technologies, and communication models, enabling the visualization of relationships between the body and technology. Such a template could serve as a canvas for sketching wearable implantable, and ingestible technologies. The suit should be interoperable with popular technology sketching systems such as Lego Mindstorms, Audrino, I/O and parallax. These applications could be used to prototype technologies that work specifically with the suit and possibly with or “in between” the other prototyping systems.

Finally, in a low-technology application, images of particular functions of the human body can be made as clothing to be worn by people. For example, children may wear the clothing to represent their internal systems including respiratory, circulatory, skeletal, or nervous systems to enable learning in a productive and fun manner.

1) A method for enabling the learning of a structure, the method comprising:
a) a learner being supplied with an envelope, the envelope being in about the shape and about the size of the structure such that it envelopes the structure, and adapted to be marked by one or more annotations using an annotation tool;
b) the learner being supplied with media operable to instruct the learner on internal characteristics of the structure; and
c) the learner being supplied with the annotation tool, the annotation tool enabling the learner to mark the envelope so as to annotate the envelope with the internal characteristics corresponding to the structure.

2) The method of claim 1, wherein the structure is a portion of anatomy.

3) The method of claim 2, wherein the anatomy is that of a human.

4) The method of claim 2, wherein the internal characteristics include bones and muscles.

5) The method of claim 4, wherein the internal characteristics further includes ligaments, nerves, blood vessels, or a combination thereof.

6) The method of claim 1, wherein the media is a series of video segments.

7) The method of claim 2, wherein the portion of anatomy is a hand.

8) A computer-network implementable system for enabling the learning of a structure, the system comprising:
a) an envelope, the envelope being in about the shape and about the size of the structure such that it envelopes the structure;
b) network accessible media operable to visually instruct a learner on one or more layers of the structure and/or one or more functions relating to the structure;
c) an annotation tool, the annotation tool enabling the learner to annotate the envelope with the internal characteristics corresponding to the structure based on the instructions provided by the media;
wherein the learner is provided with means for accessing the media via the network.

9) The system of claim 8, wherein the structure is a portion of anatomy.

10) The system of claim 9, wherein the anatomy is that of a human.

11) The system of claim 9, wherein the internal characteristics includes bones and muscles.

12) The system of claim 11, wherein the internal characteristics further includes ligaments, nerves, blood vessels, or a combination thereof.

13) The system of claim 8, wherein the media is a series of video segments.

14) The system of claim 9, wherein the portion of anatomy is a hand.

15) The system of claim 8, wherein the media is stored on a network accessible storage means and is made accessible to the learner by a web based access technique, local access technique or wide area access technique.

16) The system of claim 8, wherein the media comprises one or more photographic images and/or video segments demonstrating the one or more layers of the structure and/or functions relating to the structure.

17) The system of claim 8, wherein the media comprises web based social media learning.

18) The system of claim 8, wherein the system further comprises a database for archiving annotated envelopes, and wherein images of the annotated envelope can be captured for archiving to the database for sharing with other learners and/or evaluation by teachers.

19) The system of claim 18, wherein the system further comprises a image capture device for capturing images of the annotated envelopes.

20) The system of claim 18, wherein the envelope is a digital envelope linked to the network and wherein the images of the annotated envelopes can be captured and uploaded from the digital envelope.
